(19) United States
(12) Patent Application Publication
(10) Pub. No.: US 2005/0133551 A1
(43) Pub. Date: Jun. 23, 2005

(54) Custom fitting, hands-free, baby wrap carrier article for infants and toddlers

(76) Inventor: Elizabeth Susan Heidt, Cortland, NY (US)

Correspondence Address: Elizabeth Susan Heidt, 72 Homer Avenue, Cortland, NY, 13045, US

(21) Appl. No.: 11/005,155

(22) Filed: Dec. 4, 2004

Related U.S. Application Data
(63) Continuation of application No. 60/528,551, filed on Dec. 11, 2003.

(51) Int. Cl. A61G 1/00

(52) U.S. Cl. 224/160

(57) ABSTRACT

A custom fitting, hands-free, secure baby wrap carrier article for infants and toddlers which comprises a long rectangular piece of fabric material which is wrapped around the wearer's middle, crosses the back, over the shoulders, crossing the front of the wearer, around the waist, crossing again in the back and knotted in the front. The wearer places baby within the front crossed fabric, whether facing inward or outward and pulls the fabric around the waist up and over the baby for added security. To use the baby wrap carrier as a backpack, the wearer will wrap the fabric in the same manner, only begin wrapping from back to front.

### REFERENCES CITED [REFERENCED BY]

U.S. Patent Documents

| | | | |
|---|---|---|---|
| 416970 | Deccember, 1889 | Taylor | 2/104. |
| D266800 | November, 1982 | Kula et al. | |
| 4434920 | March, 1984 | Moore. | |
| 4606078 | August, 1986 | Tkacsik | 2/84. |
| 4757925 | July, 1988 | Knittel | 224/158. |
| 4986458 | January, 1991 | Linday. | |
| D332865 | February, 1993 | Wilmink. | |
| 5522528 | June, 1996 | Petricola. | |
| 5570823 | November, 1996 | Lindy | 224/160. |
| 5857598 | January, 1999 | Dunne | 224/158. |
| 5946725 | September, 1999 | Shatzkin et al. | 2/106. |
| 5950887 | September, 1999 | Powell. | |
| 6065655 | May, 2000 | Parewick | 224/158. |
| 6112960 | September, 2000 | Seering et al. | 224/158. |
| 6213362 | April, 2001 | Lorenzini et al. | 224/158. |

### BACKGROUND OF THE INVENTION

1. Field of the Invention

The present invention relates generally to the field of infant accessories, and still more particularly to a wrapping article or carrier for infants and children, newborn up to 45 pounds.

2. Background Discussion

It is, of course, generally known that newly-born and young babies or infants are generally carried by caregivers in a variety of carriers, slings and backpacks in order to keep the baby content, and protected while holding the baby close. Furthermore, studies show the benefits of caregivers carrying babies which include benefits to the baby's sense of security and bonding, increased development of neck and shoulder muscles and benefits to the vestibular system (balance and responding in accordance to the movements of the parent/caregiver).

U.S. patents covering various types of such swaddling and protective baby wraps are known. These include U.S. Pat. No. 06,343,727, to Leach, issued Feb. 5, 2002, which discloses one-piece baby carrier. The apparatus is in the form of a garment to be worn by an adult for carrying an infant comprising a tubular carrier portion adapted to encircle the adult wearer from the shoulders to the waist with armholes being provided along sides of the garment to create a hands-free feature of the garment.

U.S. Pat. No 5,950,887, to Powell, issued Sep. 14, 1999, discloses a baby sling having an elongated pouch of a double layer of fabric and a wide tail.

U.S. Pat. No. 5,927,576, to Nielsen, issued Jul. 27, 1999, discloses a carrying sling for infants, having a cushion-like seating.

Other known U.S. patents are U.S. Pat. No. 5,857,598, to Dunne, issued Jan. 12, 1999, which discloses an infant sling carrier with a carrier panel terminating in a tail portion extending from one end.

For various reasons, which will become apparent from the following description, the present inventor considers that her infant wrapping device provides patentable improvements over such known infant wrapping devices.

### SUMMARY OF THE INVENTION

In accordance with the present invention, there is provided a custom fitting, hands-free, secure baby wrap carrier article for infants and toddlers which comprises a long rectangular piece of cotton/lycra blend knit fabric material which is wrapped around the wearer's middle, crosses the back, over the shoulders, crossing the front of the wearer, around the waist, crossing again and knotted in the front. Said material is serged on the edges with poly, wool/nylon, nylon, cotton or elasticized thread along all sides using an overlock stitch.

The unique quality of the custom fitting, hands-free, secure baby wrap carrier article for infants and toddlers invention is in the actual wrapping technique which holds the baby in a custom fit hold every time, regardless of the shape or size of the of the child, up to 45 pounds; and also in the inclusion of fabric with enough stretch to give both caregiver and child ultimate comfort, without having so much stretch that the baby sags too low within the carrier. It should be noted that the length of the fabric is plentiful, at approximately 6 yards in length, to accommodate nearly any size caregiver. If the wearer does not have enough fabric to knot in the front, he can knot in the back without compromising the effectiveness of the wrap/carrier.

Also unique to this product is the width of the carrier at approximately 22 inches. It completely covers the shoulders and back of the caregiver, while folded in half, allowing for the most comfort while carrying baby. It will securely hold baby when wrapped folded in half, an additionally, can be unfolded while baby is inside the carrier to stretch over and completely cover the baby from head to toe for and added sense of comfort or warmth.

### BRIEF DESCRIPTION OF THE DRAWINGS

The present invention can be more readily understood by a consideration of the following detailed descriptions when taken in conjunction with the accompanying drawings, in which:

FIG. 1 is a plan view of the cloth, custom fitting, hands-free, secure baby wrap carrier article for infants and toddlers in a flat, unwrapped or fully opened condition showing the fabric shape and stitching portion. The approximate measurements are 6 yards in length and 22 inches in width, unfolded. Area 10 is the serged edge of the wrap, area 14 is the fabric, area 12 is the logo label and area 22 is the crease line where the fabric will ultimately be folded for use;

FIG. 2 is a plan view of the cloth, custom fitting, hands-free, secure baby wrap carrier article for infants and toddlers folded along the length in preparation for wrapping the body. Area 10 is the serged edge of the wrap, area 16 is the folded edge of the wrap, area 14 is the fabric and area 12 is the logo label;

FIG. 3 is a plan view showing the wearer placing the wrap around her waist. Area 18 signifies the front of the wearer, area 10 is the serged edge of the wrap, area 16 is the folded edge of the wrap, area 14 is the fabric and area 12 is the logo label;

FIG. 4 is a plan view showing the wearer crossing the wrap behind her back. Area 20 signifies the back of the wearer, area 10 is the serged edge of the wrap, area 16 is the folded edge of the wrap and area 14 is the fabric;

FIG. 5 is a plan view showing the wearer crossing the wrap in front, and tucked under the first wrap. Area 18 signifies the front of the wearer, area 10 is the serged edge of the wrap, area 16 is the folded edge of the wrap, area 14 is the fabric and area 12 is the logo label;

FIG. 6 is a plan view showing the wearer crossing the wrap around her lower back. Area 20 signifies the back of the wearer, area 10 is the serged edge of the wrap, area 16 is the folded edge of the wrap and area 14 is the fabric;

FIG. 7 is a plan view showing the wearer tying a knot in the front of the wrap. Area 18 signifies the front of the wearer, area 10 is the serged edge of the wrap, area 16 is the folded edge of the wrap, area 14 is the fabric and area 12 is the logo label;

FIG. 8 is a plan view of the child being held in a forward facing position; Area 18 signifies the front of the wearer, area 10 is the serged edge of the wrap, area 16 is the folded edge of the wrap, area 14 is the fabric and area 12 is the logo label.

### DESCRIPTION OF THE PREFERRED EMBODIMENT

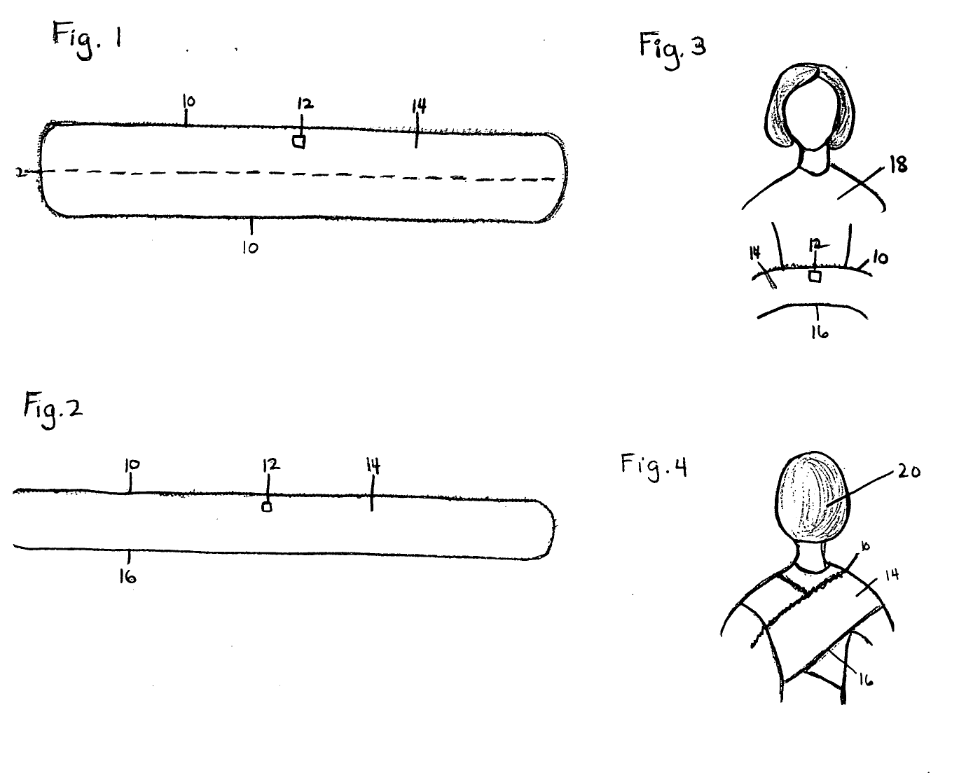

There is shown in FIG. 1 a custom fitting, hands-free, secure baby wrap carrier article for infants and toddlers, which is shown in its flat, unwrapped and fully opened condition. FIG. 2 is the same article folded along the length in preparation for wrapping the caregiver's body.

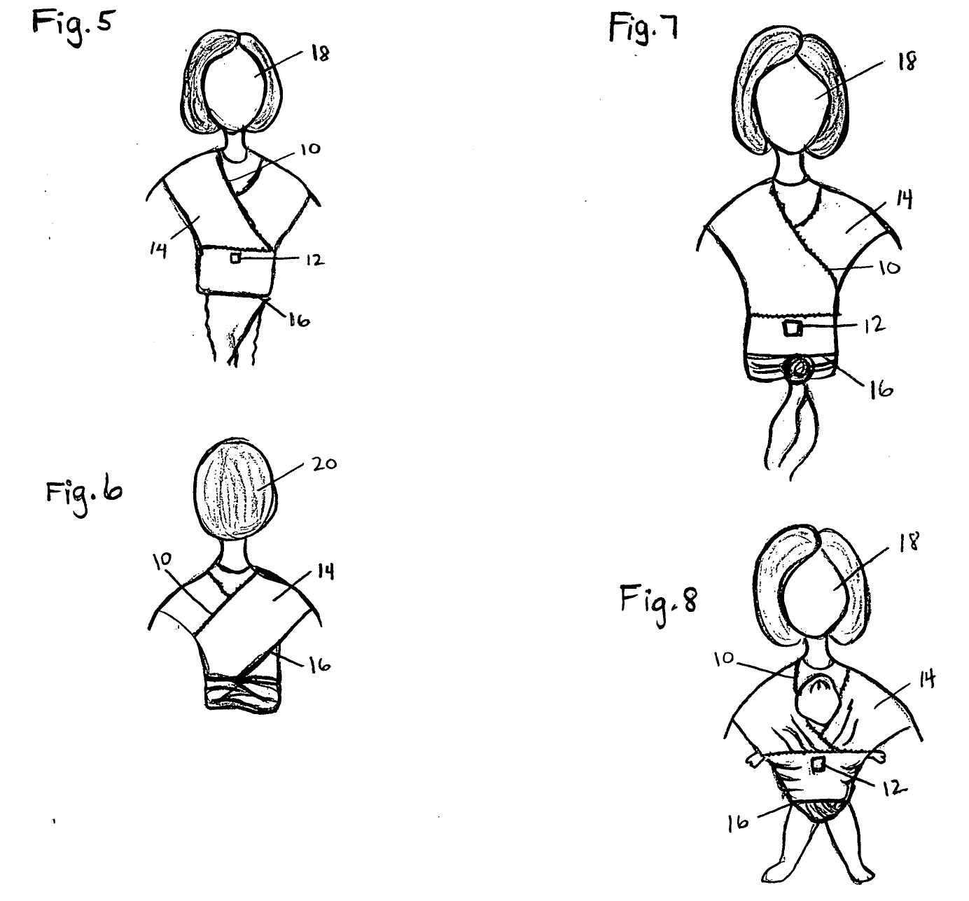

FIG. 3 through FIG. 8 show the required technique for using this custom fitting, hands-free, secure baby wrap carrier article for infants and toddlers.

The fabric is folded lengthwise. The center of the fabric, marked with a logo label, is lined up to the wearer's midsection and crossed behind his back and over each shoulder. The fabric is then crossed over the wearer's chest and tucked under the fabric with the logo label. Again, the fabric is crossed in the back and brought to the front and knotted. If the wearer does not have enough fabric to knot in the front, he can knot in the back without compromising the effectiveness of the wrap/carrier.

To use as a backpack, the fabric is again folded lengthwise. The center of the fabric, marked with a logo label, is lined up to the wearer's lower back and crossed around his midsection and over each shoulder. Again the fabric is crossed in the front and brought to the back and knotted. If the wearer does not have enough fabric to know in the back, he can knot in the front without compromising the effectiveness of the wrap/carrier.

An infant or child may be placed within the crossed sections of the fabric, once filted to the caregiver, in any number of ways. Baby may be placed facing outward, facing toward the caregiver, on the caregiver's hip, swaddled as a newborn, or on the caregiver's back facing toward the caregiver or outward.

Although there has been described above a custom fitting, hands-free, secure baby wrap carrier article for infants and toddlers in accordance with the present invention for purposes of illustrating the manner in which the present invention may be used to advantage, it is to be understood that the invention is not limited thereto. Consequently, any and all variations and equivalent arrangements, which may occur to those skilled in the applicable art, are to be considered to be within the scope and spirit of the invention as set forth in the claims, which are appended hereto as part of this application.

1. (canceled)

2. (canceled)

3. (canceled)

4. (canceled)

5. (canceled)

6. (canceled)

7. (canceled)

8. A custom fitting, hands-free, secure baby wrap carrier article for infants and toddlers which comprises a long, rectangular piece of cotton/lycra blend fabric material which is wrapped around the wearer's middle, crosses the back, over the shoulders, crossing the front of the wearer, around the waist, crossing again in the back and knotted in the front. Said material is serged along the entire perimeter with thread using an overlock stitch.

9. A custom fitting, hands-free, secure baby wrap carrier article for infants and toddlers which comprises a long, rectangular piece of cotton-blend fabric material which is wrapped around the wearer's middle, crosses the back, over the shoulders, crossing the front of the wearer, around the waist, crossing again in the back and knotted in the front. Said material is serged along the entire perimeter with thread using an overlock stitch.
